(19) United States
(12) Patent Application Publication
(10) Pub. No.: US 2006/0068075 A1
(43) Pub. Date: Mar. 30, 2006

(54) Flavored yogurt products and methods of making same

(76) Inventors: Jerry L. Fultz, Minneapolis, MN (US); Maeve C. Murphy, Plymouth, MN (US); Lisa K. Pannell, St. Louis Park, MN (US); Gary W. Stoddard, New Brighton, MN (US); Dena K. Strehlow, Maple Grove, MN (US); Alejandro A. Barajas, Minneapolis, MN (US); Richard A. Thompson, Champlin, MN (US)

Correspondence Address: GENERAL MILLS, INC., P.O. BOX 1113, MINNEAPOLIS, MN, 55440, US

(21) Appl. No.: 10/955,443

(22) Filed: Sep. 30, 2004

(51) Int. Cl. A23C 21/00

(52) U.S. Cl. 426/583

(57) ABSTRACT

The invention provides fermented dairy products composed of fermented dairy base containing active cultures and a low water activity sweet brown base component admixed within the fermented dairy base. Further, the invention provides methods for preparing fermented dairy products including steps of fermenting a dairy base by lactic fermentation to a pH of 4.7 to 5.3 to provide a fermented dairy base; cooling the fermented dairy base; admixing a sweet brown base component with the fermented dairy base to form a sweet brown flavored fermented dairy product; and packaging the sweet brown flavored fermented dairy product. Methods of formulating yogurt compositions are also described.

### FIELD OF THE INVENTION

The invention relates to food products and to their methods of preparation. More particularly, the invention relates to cultured dairy products, especially fermented yogurt products, and to their methods of preparation.

### BACKGROUND OF THE INVENTION

Yogurts typically refer to compositions produced by culturing one or more dairy ingredients with a characterizing bacterial culture that contains the lactic acid-producing bacteria, Lactobacillus bulgaricus and Streptococcus thermophilus. One or more of other optional ingredients can also be added, such as vitamins (for example, vitamin A and/or vitamin D), additional dairy products (for example, cream milk, partially skimmed milk, skim milk, or a combination of any of these), and other ingredients that can increase the nonfat solids content of the food (such as concentrated skim milk, nonfat dry milk, buttermilk, whey, lactose, lactalbumins, lactoglobulins, or whey modified by partial or complete removal of lactose and/or minerals), nutritive carbohydrate sweeteners (such as sugar, invert sugar, brown sugar, refiner's syrup, molasses, high fructose corn syrup, fructose, fructose syrup, maltose, maltose syrup, dried maltose syrup, malt extract, dried malt extract, malt syrup, dried malt syrup, honey, maple sugar, or others), flavoring ingredients, color additives, and/or stabilizers.

Yogurt is a nutritious popular dairy product. Yogurt has long been believed to be a healthy food source and thus beneficial to the body in such a way that it is seen to “enhance” the microflora of the gut. The microorganisms in yogurt, Lactobacillus bulgaricus and/or Streptococcus thermophilus, can help decrease or alleviate symptoms of lactose intolerance. The pH of yogurt products can affect the solubility and resulting absorption of minerals, such as calcium.

A natural consequence of the culturing process of yogurt production is the development of a sour or tart taste due to the production of lactic acid and acetaldehyde. The lactic acid has several benefits, including providing a clean, fresh taste and aiding preservation of the yogurt product. If the yogurt is made with good manufacturing practices and cultured to appropriate pH levels, it can be stable for several weeks under refrigeration.

At retail, yogurt is currently available in a wide assortment of varieties of texture, fat content, sweetener type and level, and flavor. Some examples of such products are low fat and nonfat varieties, as well as set style, stirred style, and whipped (also known as “aerated”) varieties. Yogurt is typically distributed and consumed with a live culture that requires refrigerated distribution (for example, in the range of about 2° C. to about 10° C.).

One broad categorization of yogurt products that is based upon manufacturing processes distinguishes between set-style yogurts versus stirred style yogurts. In the set style, the manufacturer fills cups or containers with inoculated but unfermented milk base and quiescently holds the filled cups at warm temperatures (approximately 40° to 50° C.) to allow the yogurt to ferment therein. After the desired fermenting or maturing time, the product is cooled to arrest the culturing activity and allow the body to set to form the gel-type texture of the yogurt. Set style yogurts have a relatively low initial viscosity (upon filling of the food package container) compared to the viscosity of stirred style yogurt products. As the product ferments and then is cooled, its viscosity increases to its final viscosity value. A set style yogurt is characterized by a more firm, gel-like consistency and a higher final viscosity than many stirred style yogurts. In addition to the natural thickening effect of the yogurt culture via gelation of milk proteins, a wide variety of thickeners and stabilizers are taught as useful to supplement the yogurt's gel characteristics.

Within the set style, there is a continuum of body firmness. Most set custard style products have quite firm gels, while other set style products can be much softer. The softer gel products can even be perceived by the consumer as being thinner than even certain stirred style products. One popular style variant of custard style yogurt is fruit-on-the-bottom, in which a discrete layer of fruit preserves is provided on the bottom of the yogurt container and the custard yogurt fills the remainder of the container. Fruit-on-the-top style products are similarly prepared, except that the containers are typically inverted after having been allowed to set. Typically, the yogurt phase is unflavored, although occasionally sweetened, and of a white or natural color. Other than for moisture equilibration, the yogurt layer and the fruit preserve layer typically do not intermix over time due to specific gravity and viscosity differences and the binding effect of pectin in the fruit preserves.

In the second general category of yogurt products, the yogurt is of a stirred type. In producing stirred yogurt products, the manufacturer ferments an inoculated milk base in bulk (for example, in large stirred fermentation or culturing tanks), then cools the yogurt so formed to arrest the fermentation, and subsequently fills the individual yogurt container with thickened yogurt. Production facilities for these types of yogurt products are run in a continuous or semi-continuous manner. More specifically, after fermentation to desired acidity and thickness, the yogurt is pumped through cooling heat exchangers to arrest the fermentation. The cooling also typically results in an increase in the viscosity of the yogurt. Flavorings and sweeteners can be admixed with the cooled yogurt and the yogurt is charged to containers. Conventionally, care needs to be taken to minimize the shear imparted to the yogurt in practicing such process steps to minimize the loss of thickness or viscosity built up by the fermentation step as augmented by cooling.

Alternatively, a two-step cooling process can be used in producing stirred yogurt products. In a two-step process, the manufacturer ferments an inoculated milk base in bulk (for example, in large stirred fermentation or culturing tanks), then cools the yogurt products so formed to a temperature of about 21° C. to begin arresting the fermentation, then subsequently fills the individual yogurt container with thickened yogurt. Thereafter, the individual yogurt container is placed in refrigeration temperatures of about 1° C. to about 10° C. to quiescently cool the yogurt products and arrest the fermentation.

Thus, the stirred style yogurt typically has a higher viscosity than set style yogurts upon filling due to the lower temperature and the thickening affect of yogurt culture. Nonetheless, the stirred style yogurt typically builds or increases substantially in viscosity after filling over time until reaching its intended finish viscosity.

Many variations in stirred style yogurts also exist. For example, fruit preserves or purees can be stirred into the stirred yogurt immediately prior to filling. Such stirred style yogurts comprising intermixed fruit purees are sometimes referred to as “Swiss,” or “Continental” or “French” style. In addition, “parfait” style yogurt products have more recently become commercially available. These types of yogurts typically consist of two or more distinct layers of differently colored and/or flavored stirred style yogurt layers or portions and/or fruit pieces or other particulates.

Another recent innovation in yogurt food products has been the development of aerated yogurts. Aerated or whipped yogurts can be characterized as having a density reduced from a native range of 1.1 to 1.2 g/cc (depending upon such factors as sugar content, fruit content, and the like) to a range of 0.30 to 1.0 g/cc. Such products are described, for example, in U.S. Publication No. 2003/0068406 (Nair et al.) and 2003/0224089 (Engesser et al.)

As can be appreciated from the above description of the numerous styles and flavors within styles of yogurts, product proliferation and differentiation is an important characteristic of commercial yogurt manufacture. In this highly competitive food product category, there is a continuing desire to develop novel products exhibiting distinctive visual, taste, and textural variations in order to stimulate interest in yogurt products.

To this end, recent efforts have been directed to developing a chocolate yogurt. One challenge that has hampered such efforts is related to the characteristic tartness of yogurt having an undesirable flavor impact on chocolate. Yogurt is a typically highly acidic product, usually with a pH of less than 4.6. This acidic environment negatively impacts flavors that are delivered via a neutral or alkaline media (for example, “sweet brown” flavors such as chocolate, caramel, dulche de leche, vanilla, coffee, as well as flavors of oleaginous fruits such as walnut, hazelnut, almond, pistachio, cashew, and the like).

Attempts to reduce the acid flavor by the use of buffering salts, post fermentation, is generally not effective because the salts tend to increase the pH to an extent that product preservation cannot be assured. It is generally believed that pH levels of yogurt products, during manufacture and storage, should be maintained below 4.6 for good product preservation. In addition to the affect on pH, the buffering tends to add an off-flavor, incompatible with both yogurt and chocolate. Heating the yogurt to assure stability kills the active cultures, making the product less desirable to many consumers who desire a product having live cultures. Further, the simple addition of sugar cannot overcome the sourness of the yogurt, to thereby provide a chocolate flavor. The addition of large amounts of buffering salts, starch or other materials can either affect the process of fermentation or reduce the stability of the final product.

In one exemplary approach to producing a chocolate-flavored yogurt, a compartmentalized package containing a yogurt in one compartment and a chocolate syrup, chocolate pudding, or chocolate powder in a separate compartment have been provided. See, for example, U.S. Pat. No. 6,068,865 (Lee et al.). The yogurt and chocolate components are thus maintained separate during storage and are then blended by the consumer just prior to consumption.

Another approach is described in U.S. Patent Publication No. 2004/0013769 (O'Sullivan et al.), wherein yogurt containing live and active cultures is provided with confectionery pieces dispersed within the yogurt. According to this approach, liquid chocolate is discharged into cooled fermented stirred style dairy base, whereby liquid chocolate is shattered into filament particulates upon contact with a cooled, fermented dairy base.

However, prior approaches have not yet provided a chocolate yogurt product that exhibits a balanced flavor—that is, flavor that maintains both the rounded, sweet brown flavors from the chocolate component, as well as the characteristic tartness of typically yogurt—and thus is organoleptically pleasing to consumers.

### SUMMARY OF THE INVENTION

The invention relates generally to cultured (fermented) milk based products, preferably yogurt products having sweet brown flavors. The yogurt products contain living cultures and exhibit a pH of 4.7 or higher, preferably a pH in the range of 4.7 to 5.3. Preferred yogurt products provide desirable organoleptic characteristics, such as a rich, balanced sweet brown flavors in combination with a mild yogurt flavor. In preferred aspects, the yogurt products are prepared with a low water activity sweet brown base that does not adversely impact the microbial stability of the yogurt product and can assist in provision of the desired organoleptic qualities to the food product. The resulting yogurt products can thus provide sweet brown flavors typically associated with such foods as chocolate, while preserving the desirable properties of yogurt products (such as nutritive qualities associated with yogurt).

As described herein, the term “yogurt” includes, but is not limited to, all of those food products meeting the definition as set forth in 21 C.F.R. Section 131.200, 131.203, and 131.206. The food can be homogenized and is pasteurized or ultra-pasteurized prior to addition of bacterial culture. Flavoring ingredients can be added after pasteurization or ultra-pasteurization. To extend the shelf life of the food, yogurt can be heat treated after culturing is completed, to destroy viable microorganisms. Typically, yogurt is stored at refrigerated temperatures (in the range of about 1° C. to about 10° C.) and is stable for several weeks, for example, about 6 weeks.

Surprisingly, it has been discovered that manipulation of the pH levels during production of the fermented dairy product, can provide a food product that not only provides a more sweet brown taste (for example, chocolate taste), but also maintains the desirable characteristics of yogurt products. For purposes of illustrating the invention, certain terminology is adopted to describe the pH levels and stability of the inventive food products. As used herein, the pH at which fermentation is halted is referred to as the “initiai pH,” while the pH at which the yogurt product settles after a period of storage at refrigerated temperatures (e.g., three weeks or more) is referred to as the “product pH.”

“Refrigerator stable” refers to the compositions of the invention being suitable for storage at desirable temperatures, in this case, refrigeration temperatures typically in the range of about 45° F. or less (7° C. or less) without the food composition substantially breaking down, for example, by microbial contamination, syneresis or weeping, water accumulation, and the like, and becoming unsuitable for consumption. In turn, the shelf life of the food products described herein refers to the period of time from formulation of the food product until the time at which the food product becomes unsuitable for consumption (for any one or more of the reasons illustrated herein).

Thus, one aspect of the invention relates to methods of formulating yogurt products, wherein a mild yogurt culture is selected to provide a maximum pH change of 0.2 or less from the initial pH over the shelf life of the yogurt product. According to this aspect of the invention, significant flexibility in formulating yogurt compositions to include a wide variety of flavor components is provided, while the characteristic nutritive and flavor components of typical yogurt is maintained and/or enhanced. As a result of this aspect of the invention, yogurt compositions can be formulated to include sweet brown flavor components, as well as other flavor components that might not otherwise be considered “compatible” with typical yogurt flavors.

In some aspects, the invention relates to novel yogurt compositions themselves. In one embodiment, for example, a fermented yogurt base is provided having an initial pH in the range of 4.7 to 5.2, or 4.8 to 5.1, or 4.9 to 5.0, and a sweet brown base is added to the fermented yogurt base at this initial pH, along with any optional additional flavors, flavor enhancers, or the like. Upon addition of the sweet brown base, the pH of the inventive compositions typically increases to a level of about 4.8 to 5.3. Under storage at refrigerated temperatures over a period of time, the pH of the yogurt product settles to a product pH of approximately 4.7 to 5.3. The inventive yogurt products thus exhibit elevated pH levels during manufacture and storage relative to typical yogurt products. Surprisingly, the elevated pH levels do not adversely impact the stability or organoleptic qualities of the yogurt products.

In some aspects, the inventive products and methods utilize a sweet brown base having a low water activity. In preferred aspects, the water activity of the sweet brown base is 0.85 or less. A sweet brown base having a water activity of 0.85 or less can be admixed directly with fermented yogurt base, as described in more detail herein. Alternatively, the sweet brown base plus additional flavor(s) can be admixed simultaneously with the fermented yogurt base. Alternatively, the sweet brown base and the flavor can be admixed together. Thereafter, the combination can be admixed with the fermented yogurt base. According to the invention, the sweet brown base (and flavor, when also included) does not compromise the desirable properties of the yogurt base.

In another aspect, the invention relates to methods of preparing yogurt compositions that exhibit desirable organoleptic properties, the methods involving controlling the initial and product pH levels of the yogurt product to balance the flavor components of the yogurt product.

More particularly, the invention provides a fermented dairy product comprising (a) fermented dairy base containing active cultures; and (b) a low water activity sweet brown component admixed within the fermented dairy base. In some aspects, the low water activity sweet brown component is a low water activity chocolate base.

The invention further provides methods for preparing a fermented dairy product comprising steps of: (a) fermenting a dairy base by lactic fermentation to a pH of 4.7 to 5.2 to provide a fermented dairy base; (b) cooling the fermented dairy base; (c) admixing a sweet brown base component with the fermented dairy base to form a sweet brown flavored fermented dairy product; and (d) packaging the sweet brown flavored fermented dairy product. In some aspects, the sweet brown base component is a chocolate base component, and the flavored fermented dairy product is a chocolate flavored fermented dairy product.

In still further aspects, the invention provides methods for formulating a fermented dairy composition comprising: (a) selecting a bacterial culture for fermentation of a dairy base; (b) mixing the bacterial culture with a dairy base; (c) fermenting the dairy base with the bacterial culture to achieve a fermented dairy base having an initial pH level; (d) cooling the fermented dairy base to arrest fermentation and thereby form a fermented dairy product; (e) maintaining the fermented dairy product at refrigerated temperatures for a selected time; (f) subsequently determining a pH of the fermented dairy product; (g) comparing the initial pH level with the pH of the fermented dairy product to determine a pH change; and (h) selecting a bacterial culture that provides a pH change of 0.2 or less.

In further aspects, the invention provides refrigerator stable, fermented dairy products comprising fermented dairy base containing active bacterial cultures, wherein the active bacterial cultures provide a maximum pH change of 0.2 over shelf life of the fermented dairy product.

The various aspects of the invention will now be described in more detail.

### DETAILED DESCRIPTION

The embodiments of the present invention described below are not intended to be exhaustive or to limit the invention to the precise forms disclosed in the following detailed description. Rather, the embodiments are chosen and described so that others skilled in the art can appreciate and understand the principles and practices of the present invention.

The present invention is directed to fermented dairy products that are formulated to include sweet brown flavors and to exhibit desirable organoleptic attributes. The fermented dairy products can be provided in the form of a yogurt, such as any conventional style of yogurt, including set style, stirred style, aerated style, and the like. In one preferred embodiment, the invention relates to fermented dairy products that can be provided with a light texture, such as an aerated yogurt composition (also known as a “fermented mousse”).

To facilitate the discussion of the invention, use of the invention to provide chocolate yogurt products, will be addressed. Chocolate yogurt products are selected because the provision of chocolate flavored yogurt has long presented technical challenges (as described herein). Further, the advantages of the invention can be clearly presented. However, it is understood that the compositions and methods disclosed are applicable to any fermented dairy products, such as firm yogurt, drinkable yogurt, soft cream cheeses, soft cheeses including fromage frais and quark, fermented milk, yogurt-based or fermented milk desserts, smoothies, and the like. Further, the inventive compositions and methods described herein are applicable to any yogurt compositions, for example, the various styles mentioned herein, as well as the various fat levels (including low fat, nonfat, and standard yogurt). Moreover, it is understood that the inventive compositions and methods generally provide mild yogurt products that can be utilized in a wide variety of applications. While the present description will focus on utilization of the inventive concepts to provide sweet brown flavored yogurt products, it is readily apparent that the invention can be utilized to provide mild, unflavored yogurt products, as well as yogurt products with flavors other than sweet brown flavors.

In its product aspect, the invention provides sweet brown flavored yogurt compositions. These yogurt compositions provide surprisingly rounded organoleptic attributes while maintaining shelf stability desirable for such products. During the expected refrigerated shelf life, the inventive products can maintain their balanced organoleptic attributes.

It has been surprisingly discovered that parameters relating to ingredients and processing can be controlled to provide inventive flavored compositions. In some aspects, the invention relates to utilization of a low water activity sweet brown base component that is admixed with the yogurt base to provide an evenly flavored yogurt product that can be stored at refrigerated temperatures for periods of time typical for commercially available yogurt products. In some aspects, the invention relates to control of pH levels to provide yogurt products that have elevated pH levels during manufacture as well as refrigerated storage, yet provide a mild yogurt product with sweet brown flavors. Thus, in some embodiments, a chocolate flavor component having a low water activity can be incorporated in a yogurt product without compromising the desirable organoleptic and/or health attributes of the yogurt product.

Throughout the specification and claims all percentages used herein are in weight percentages, and are based upon the total weight of the yogurt composition.

According to the invention, fermented dairy compositions having a sweet brown flavor are provided by preparing a yogurt base and admixing a sweet brown base component and/or additional sweet brown flavor (added separately or in combination) within the yogurt base, thereby forming a sweet brown yogurt product that can be stored under refrigerated conditions for consumption. The sweet brown base component (and additional flavor, when included) is thus distributed throughout the yogurt product prior to packaging and storage, in contrast to prior yogurt products that included such flavors (such as chocolate) as a separate component.

Generally, the fermented dairy compositions are formulated by forming or providing a dairy base comprising at least one fermentable dairy ingredient. The fermentable dairy ingredient can comprise raw milk or a combination of whole milk, skim milk, condensed milk, dry milk (for example, dry milk solids non-fat, or MSNF), grade A whey, cream, and/or such other milk fraction ingredients as buttermilk, whey, lactose, lactalbumins, lactoglobulins, or whey modified by partial or complete removal of lactose and/or minerals, and/or other dairy ingredients to increase the nonfat solids content, which are blended to provide the desired fat and solids content. In preferred embodiments, the fermentable dairy ingredient does not require any processing, in addition to standard homogenization and/or pasteurization, prior to use in the dairy base (for example, the inventive concepts do not require pre-processing of the fermentable dairy ingredient to remove such materials as minerals, proteins, or any other like substances). If desired, the dairy base can include a filled milk component, such as a milk ingredient having a portion supplied by a non-milk ingredient (for example, oil or soybean milk).

Preferably, the fermentable dairy ingredient is composed of bovine milk. However, other milks can be use as a partial or whole substitute for bovine milk, such as camel, goat, sheep or equine milk. In some embodiments, the dairy base can comprise a vegetable milk such as soymilk.

Optionally, the dairy base can include sweeteners. In some embodiments, the dairy base can include one or more nutritive carbohydrate sweetening agents. Exemplary nutritive sweetening agents include, but are not limited to, sucrose, high fructose corn syrup, dextrose, various DE corn syrups, beet or cane sugar, invert sugar (in paste or syrup form), brown sugar, refiner's syrup, molasses, fructose, fructose syrup, maltose, maltose syrup, dried maltose syrup, malt extract, dried malt extract, malt syrup, dried malt syrup, honey, maple sugar, and mixtures thereof. In some embodiments, particularly in low fat and/or low calorie variations, the dairy base can comprise a high potency non-nutritive carbohydrate sweetening agent. Exemplary high potency sweetening agents include aspartame, sucralose, acesulfame potassium, saccharin, cyclamates, thaumatin, tagatose and mixtures thereof.

The fermentable dairy ingredients and sweeteners (when included) can be blended in a mix tank. Minor ingredients can be added into the mix tank at this stage, when desired. Examples of minor ingredients include stabilizers and thickeners such as starch, gelatin, pectin, agar, carageenan, and mixtures thereof.

Optionally, the dairy base can include calcium sequestrant in amounts sufficient to reduce the occurrence of premature precipitation of the protein content in the dairy base. By premature protein precipitation is meant any protein coagulation during the heating (e.g., pasteurization) or cooling steps. It is desirable that thickening of the dairy product occurs after the heat treatment such as during the fermentation step.

Exemplary soluble calcium sequestrants include, but are not limited to, sodium or potassium citrates (for example, trisodium citrate), phosphates, acetates, tartrates, malates, fumarates, adipates, ascorbates, and mixtures thereof. Good results are obtained when the sequestrant(s) is present at about 0.025% to about 0.15%.

The dairy base ingredients are admixed to form a homogeneous or well-blended mix. Next, the dairy base is optionally homogenized in a conventional homogenizer to disperse evenly the added materials and the fat component supplied by various ingredients, thereby forming a homogenized dairy blend. If desired, the dairy base can be warmed prior to homogenization from typical milk storage temperatures of about 5° C. to temperatures of about 65° to about 75° C., preferably about 73° C. In some embodiments, homogenization is performed in a two-stage homogenizer, with a target pressure of about 1000 psi in the first stage, and a target pressure of 500 psi in the second stage.

The homogenized dairy blend is then essentially heat treated or pasteurized, typically by heating for times and temperatures effective to accomplish pasteurization to form a pasteurized or heat-treated dairy blend. As is well known, the dairy blend can be heated to lower temperatures for extended times (for example, 88° C. for 30 minutes) or alternatively higher temperatures for shorter times (for example, 95° C. for about 38 seconds). Intermediate temperatures for intermediate times can also be employed, as well known in the art. Other pasteurization techniques or, less preferably, even sterilization, can be practiced (such as light pulse, ultra high temperature, ultra high pressure, and the like) if effective and economical. In certain commercial practices, the sequence of the homogenization and pasteurization steps can be reversed.

In preferred embodiments, the homogenized and pasteurized dairy blend is then brought to incubation temperature, usually in the range of about 40° C. to about 46° C. When heat pasteurization is employed, a cooling step after pasteurization can be used, wherein the homogenized and pasteurized dairy blend is cooled to a desirable incubation temperature.

Thereafter, the homogenized and pasteurized dairy blend is inoculated with at least one microorganism capable of carrying out lactic fermentation (often referred to as a “starter culture,” such as a starter yogurt culture). Typically, a yogurt starter culture includes a combination of Lactobacillus sp. and Streptococcus sp. (for example, Lactobacillus bulgaricus and/or Streptococcus thermophilus). In other variations, the yogurt culture can additionally include a Lactobacillus sp. such as Lactobacillus lactis, Lactobacillus casei and/or Lactobacillus acidophilus. In other variations, the culture can include Bifidobacterium lactis, Bifodobacterium bifidus, Lactococcus cremoris, Lactococcus lactis, Lactococcus lactis ss diacetyllactis and combinations thereof. Any microorganism suitable for lactic fermentation that accomplishes the pH control described herein can be used in accordance with the invention.

According to the invention, the bacterial culture is chosen to provide the pH control during manufacture and storage of the compositions as described herein. Thus, in some embodiments, thermophilic culture blends are chosen as the starter culture, in order to allow the provision of an initial pH of about 4.7 to about 5.3 and a product pH of 4.7 or higher. In some embodiments, mesophilic culture blends are chosen as the starter culture, for example, in production of a cream cheese embodiment. As described herein, after addition of sweet brown component to the fermented dairy blend, the pH will typically increase, for example, to about 5.3. However, the pH of the flavored fermented yogurt composition will settle over refrigerated storage. The bacterial cultures are selected to accommodate the pH changes and maintain the pH level within a desired range over product formulation and storage conditions. Preferably, the culture blends are chosen so that the maximum pH change is 0.2 or less from the initial pH to the end of shelf life (for example, from the time the product is placed into a container (at the time of packaging) to the settled product pH). Yogurt starter cultures are widely commercially available, and particular strains can be selected based upon criteria such as the pH profiles described herein. Illustrative yogurt cultures are commercially available from Chr. Hansen (Milwaukee, Wis.) under Product Nos. YC180, YF-L702 or YF-L703, and from Danisco Foods under Product No. ABDV52 (Copenhagen. Denmark).

Surprisingly, it has been discovered that bacterial cultures can be selected to provide “mild” tasting yogurt products that maintain the “mild” taste over the extended shelf life of the product at refrigerated temperatures. The selection of these bacterial cultures provides the ability to moderate the pH change over shelf life of the yogurt products. For conventional yogurt products that contain typical starter cultures, the pH would continue to drop over the shelf life of the product at refrigerated temperatures. Moreover, this pH drop would be even more dramatic if the yogurt product encountered temperature abuse over the shelf life of the product (for example, during shipping of the product). In contrast, the inventive yogurt products provide a more controllable pH level that is predictable over shelf life of the products.

In one aspect, the culture chosen can provide mild fermented dairy products. Mild yogurt products, for example, provide mild flavors as a result of reduced lactic acid production, as well as reduced acetaldehyde production. The resulting yogurt product exhibits a mild, yet characteristic flavor typically associated with yogurt products.

According to the invention, the homogenized and pasteurized dairy blend is fermented for a suitable time at a suitable temperature, to achieve a fermented dairy blend having a desired pH. In one embodiment, the homogenized and pasteurized dairy blend is fermented until the pH of the inoculated dairy blend reaches approximately 4.7 or greater, or about 4.7 to about 5.3, or about 5.0 (the initial pH). Depending upon the temperature, solids content, ingredients such as sweetening agents, preservatives, stabilizers, etc. and amount of culture added, this can take from about three to about 14 hours. In some embodiments, fermentation is performed at a temperature in the range of about 37° C. to about 46° C. (about 100° F. to about 115° F.) for about 5 hours. When the inventive methods are utilized to prepare a stirred style yogurt product, for example, it is important that the mixture agitation be minimized during the fermentation process to allow proper curd formation. After fermentation to desired acidity and thickness, the fermented dairy blend is pumped through cooling heat exchangers to arrest the fermentation. At this stage, the fermented dairy blend is sufficiently cooled to temperatures at which the cultures are not actively fermenting the dairy blend and thus do not substantially change the pH. Typically, product can be cooled to temperatures of about 10° C. to about 20° C. or less. In some embodiments, product can be cooled to temperatures of about 4° C. or less (about 40° F. or less). The temperature at which fermentation is arrested can depend upon the particular bacterial cultures selected, and can be readily determined by one of skill in the art using standard techniques.

In some embodiments, a suitable preservative or combination of preservatives can be added to the fermented dairy blend after fermentation is halted. When included, the preservative(s) can be added to provide a concentration up to about 0.1% of the yogurt composition. Any suitable preservative can be utilized, such as mold and yeast inhibitors, for example, potassium sorbate, sorbic acid, dehydroacetic acid, sodium benzoate, and the like).

The fermented dairy blend can then be maintained at a cooled temperature for a suitable period of time, if desired (for example, temperatures of 4° C. or less).

In some embodiments, it can be desirable to provide a hydrated emulsifier blend to the fermented dairy blend at this stage. The emulsifier component can aid in providing a shorter texture, body, and a creamy mouthfeel. Emulsifiers can further stabilize the water and fat components of the composition, provide the desired texture and mouthfeel attributes in the inventive compositions, increase the viscosity, and prevent composition breakdown due to moisture weeping. Emulsifiers can also effectively aid in aerating the final product, when desired, toward its target density of 0.8 g/cc or less, or in the range of about 0.7 to about 0.73 g/cc, or about 0.71 to about 0.72 g/cc.

For example, a hydrated emulsifier blend can be admixed at a temperature of about 4° C. to about 30° C. with the fermented dairy blend to form a yogurt blend. This admixture step can be performed at a temperature in the range of about 4° C. to about 15° C., or in the range of about 4° C. to about 7° C. Suitable hydrated emulsifiers and methods of preparing them are described, for example, in U.S. Patent Publication No. 2003/0054086 A1 (Murphy et al., published Mar. 20, 2003). As described in this co-owned patent publication, the hydrated emulsifier blend can comprise about 0.5% to about 1.5% of a wetting agent, about 3% to about 15% of a hydrated lactylated mono- and di-glycerides, and the balance water (the percentages based upon the weight of the aqueous dispersion). The hydrated emulsifier blend can be pasteurized and cooled to a temperature in the range of about 4° C. to about 30° C., or 4° C. to about 15° C., or about 4° C. to about 7° C.

The hydrated emulsifier blend preparation methods according to these embodiments can comprise preparing an at least pasteurized hydrated emulsifier composition. In some embodiments, this first step can involve a first sub-step of adding a first emulsifier or wetting agent to hot water to form a clear mixture. The wetting agent facilitates dispersion of the lactylated emulsifiers in the water to form the hydrated emulsifier composition. The wetting agent can be selected from the group of polysorbates, propylene glycol esters, sodium dodecyl sulfate, sodium stearyl lactylate, diacetyl tartaric acid esters of monoglycerides and mixtures thereof.

The amount of wetting agent added to the composition has a direct effect on the viscosity of the hydrated emulsifier. Since the hydrated emulsifier will be added at refrigerated temperatures (typically about 1° C. to about 7° C.) to the refrigerated dairy blend for ease of handling and mixing without imparting shear to the dairy blend, the hydrated emulsifier composition is desirably characterized by a thin texture (a low viscosity). Thus, in some embodiments, low viscosity hydrated emulsifier compositions have viscosities in the range of about 5,000 to about 40,000 cps, or about 10,000 to about 25,000 cps when added to cultured dairy products at refrigeration temperatures.

The first step in preparing a hydrated emulsifier blend can further include a second sub-step of adding a second emulsifier ingredient that is an emulsifier blend of lactylated mono- and di-glycerides to the intermixed wetting agent and hot water. The lactylated blend of mono- and di-glycerides can be selected from the group of lactylated mono- and di-glycerides, citrate acid esters of mono- and di-glycerides, and distilled monoglycerides. In some embodiments, gentle agitation can be beneficially maintained throughout the preparation of the hydrated emulsifier.

The hydrated emulsifier blend can comprise about 5% to about 15% of the second emulsifier blend, when included.

The completion of the hydration can be visually determined by observing the formation of a white viscous mass that gradually thickens as it is cooled to a temperature of 4° C. to about 30° C., or about 4° C. to about 15° C., or about 4° C. to about 7° C. The admixed hydrated emulsifier blend has a native pH in the range of 6.0 to 6.5.

The third step of this embodiment comprises at least pasteurization of the hydrated emulsifier. Since it is intended that the hydrated emulsion can be added directly to an already fermented dairy blend, pasteurization can provide bacteriological stability for a blended fermented dairy/hydrated emulsifier product that does not receive further bacteriological treatment such as heat processing. Also, pasteurization is desirable to allow for production of the hydrated emulsifier blend at one production facility and transportation to a separate dairy product manufacturing facility with a reduction in the spoilage tendency of the hydrated emulsifier during transport and storage.

As described herein, admixture of the hydrated emulsifier blend is typically accomplished after fermentation of the fermented dairy blend. Such post-pasteurization addition in turn desirably allows the fermented dairy blend to be prepared with high temperature, short time (“HTST”) pasteurization, and the hydrated emulsifier to be prepared via batch pasteurization, if desired. In some embodiments, the hydrated emulsifier blend can be admixed with the pasteurized dairy blend prior to fermentation. According to these embodiments, pasteurization of the hydrated emulsifier can be desirable to prevent the degradation of a pasteurized dairy blend when admixed.

The hydrated emulsifier blend pasteurization step can be accomplished either through batch pasteurization or HTST pasteurization. In some aspects, batch pasteurization can be preferred, as the hydrated emulsifier does not develop a high viscosity as a result of this technique. The viscosity of the hydrated emulsifier is dependent, at least in part, on the amount of shear the hydrated emulsifier undergoes. Batch pasteurized hydrated emulsifier does not develop a high viscosity, whereas HTST as a result of a high flow of product and pumping can develop a fair amount of shear and a high viscosity. Although it can be more important to agitate the hydrated emulsifier pasteurized via HTST, in order to control and lower the viscosity, agitation during cooling is typically helpful in controlling the critical viscosity of the emulsifier.

According to the invention, continuous agitation of the hydrated emulsion is preferred during cooling to reduce the chances of large increases in viscosity.

The hydrated emulsifier blend can optionally be admixed with an edible organic acid prior to addition to the dairy blend. In preferred embodiments, the hydrated emulsifier blend pH can be lowered with the addition of an edible organic acid from a native pH in the range of 6.0 to 6.5, to a pH in the range of about 3.7 to 4.7 prior to admixture with a dairy blend, in order to minimize acid shock to the dairy blend (which, at this stage, exhibits a pH in the range of about 4.9 to about 5.1). In the edible organic acid admixed with hydrated emulsifier embodiment, the hydrated emulsion blend can be characterized by a pH in the range of about 3.7 to about 4.7, or about 4.2 to about 4.7, or about 4.5. Such low pH hydrated emulsions have a shelf life of up to three months at refrigerated temperatures, thus allowing extended storage of the hydrated emulsifier blend prior to admixture with the pasteurized dairy blend. The pH can be conventionally lowered by adding an edible acid to the hydrated emulsion such as edible organic acids selected from the group of citric acid, lactic acid, malic acid, succinic acid, tartaric acid, and mixtures thereof. The acid addition can be achieved by several methods that are within the skill of an artisan in this technology. In some embodiments, citric acid can be used for taste and cost considerations. In other variations, buffer systems (for example, mixtures of citric acid and sodium citrate) can be used.

Optionally, the hydrated emulsifier can be admixed with a fruit preparation base prior to admixture with the dairy blend. This method can additionally alleviate acid shock to a yogurt blend. In the fruit base/hydrated emulsifier variation, the pH of the hydrated emulsifier blend can be lowered to about 4.0 to 4.7 by co-blending the cooled pasteurized hydrated emulsifier blend with an aseptic fruit preparation base in a weight ratio of hydrated emulsifier blend to fruit preparation base of about 1:1 to about 1.25:1, to form an emulsion bearing fruit preparation base. The emulsion bearing fruit preparation base can then be added to the dairy blend.

The fermented dairy blend in combination with the hydrated emulsifier can be admixed gently at about 5 to about 15 rpm. Typically, the hydrated emulsifier is added in an amount sufficient to stabilize air cells formed during aeration processes. Typical amounts can be in the range of about 2% to about 6%, or about 3% to about 4%, based upon the weight of the pasteurized yogurt product at this stage.

According to the invention, a sweet brown base component (such as a chocolate base) is added to the fermented dairy blend and admixed therewith to provide a flavored fermented dairy blend having the sweet brown base component well blended therein. In some embodiments, the sweet brown base component is provided in the form of a syrup, such as a chocolate, dark chocolate, chocolate liquor, semi sweet chocolate, cocoa, dutched cocoa or milk chocolate syrup. In one such embodiment, the milk chocolate syrup is composed of dextrose, water, milk chocolate, and cocoa. Another suitable chocolate syrup is a chocolate syrup composed of dextrose, water, sweet chocolate, and cocoa.

According to some embodiments of the invention, the sweet brown base component can be characterized as a low water activity sweet brown base component. In some embodiments, the low water activity sweet brown base component water activity can be achieved via addition and/or adjustment of the weight percentage of optional ingredients such as fructose, sucrose, glucose, propylene glycol, glycerol, polyhydric alcohols (for example, mannitol, lactitol, isomalt, xylitol, sorbitol, maltitol), sodium chloride and combinations thereof, based upon the total weight of the low water activity sweet brown base component. In some embodiments, the sweet brown base component can exhibit a water activity (potassium chloride calibration) of 0.85 or less.

In some aspects, the sweet brown base component can be characterized as having a total solids (70° C. vacuum oven, 16 hours) in the range of 65% to 75%, a Brix level in the range of about 63.0 to 73.0 degrees, pH in the range of about 5.2 to 7.0.

In some embodiments, the sweet brown base component can be characterized as having a total fat content in the range of 0% to about 25%. Exemplary fat components include, but are not limited to, cocoa butter, vegetable oil, vegetable shortening, butter, dairy cream and mixtures thereof.

In some embodiments, the sweet brown base component can be characterized as having a total sweetening agent content in the range of about 0% to about 75%. Exemplary sweetening agents include, but are not limited to, sucrose, high fructose corn syrup, dextrose, various DE corn syrups, beet or cane sugar, invert sugar (in paste or syrup form), brown sugar, refiner's syrup, molasses, fructose, fructose syrup, maltose, maltose syrup, dried maltose syrup, malt extract, dried malt extract, malt syrup, dried malt syrup, honey, maple sugar, and mixtures thereof.

In some embodiments, the sweet brown base component can optionally include ingredients such as condensed milk, sweetened condensed milk, caramel, flavors (for example vanillin) and combinations thereof.

The sweet brown base component may be processed by heat to destroy any pathogenic microorganisms (such heat treatments may include, but are not limited to pasteurization, or commercial sterilization).

When the sweet brown base comprises a chocolate base, such chocolate bases can be obtained from any of a variety of commercial sources (for example, Degussa Food Ingredients, Gmbh, Trostberg, Germany, The J. M. Smuckers Company, Orrville, Ohio, and Atys US Inc., Brecksville, Ohio). Typically, the sweet brown base components utilized in accordance with the inventive concepts are provided in the form of syrups. The sweet brown base component is added in an amount sufficient to provide desirable organoleptic attributes to the yogurt composition, such as sweet brown, rounded flavors. Typically, the sweet brown base component is added in an amount in the range of about 5% to about 15%, or about 7% to about 10%, or about 8% to about 9%, based upon the total weight of the fermented dairy blend after admixture with the sweet brown base component.

In some embodiments, the sweet brown base component is provided to the fermented dairy blend at refrigerated temperatures, but this is not required in accordance with the invention.

Optionally, the inventive compositions can further include a variety of adjuvant materials to modify the nutritional, organoleptic, flavor, color, or other properties of the composition. For example, the yogurt compositions can additionally include synthetic and/or natural flavorings, and/or coloring agents can be used in the compositions of the invention. Any flavors typically included in yogurt compositions can be used in accordance with the teachings of the invention. Also, flavor materials and particulates, such as fruit and fruit extracts, nuts, chips, and the like, can be added to the yogurt compositions as desired. The flavoring agents can be used in amounts in the range of about 0.01 to about 3%. Coloring agents can be used in amounts in the range of about 0.01 to 0.2%.

When included, fruit sauces or purees can comprise about 5 to about 15% of the yogurt product. As discussed herein, the fruit component can be admixed with the emulsifier prior to addition to the pasteurized dairy blend, or can be added as a separate component, as desired.

In the manufacture of Swiss-style yogurt, a fruit flavoring can be blended substantially uniformly throughout the yogurt after fermentation is complete but prior to packaging. A static mixer can be used to blend the fruit component into the yogurt with minimal shear.

In the manufacture of “sundae” style yogurt, fruit flavoring can be deposited at the bottom of the container, and the container can then be filled with the yogurt mixture. To prepare a sundae style yogurt product employing a stirred style yogurt, the dairy base is prepared with added thickeners and/or stabilizers to provide upon resting a yogurt texture that mimics a set style yogurt. In this variation, the fruit is added directly to the container, typically to the bottom, prior to filling with the yogurt.

The fruit flavoring can be provided as a sauce or puree and can be any of a variety of conventional fruit flavorings commonly used in yogurt products. Typical flavorings include strawberry, raspberry, blueberry, strawberry-banana, boysenberry, cherry-vanilla, peach, pineapple, lemon, orange, and apple. Generally, fruit flavorings include fruit preserves and fruit or fruit puree, with any of a combination of sweeteners, starch, stabilizer, natural and/or artificial flavors, colorings, preservatives, water, and citric acid or other suitable acid to control the pH. Minor amounts of calcium can be added to the fruit to control the desired texture of the fruit preparation typically provided by a soluble calcium material such as calcium chloride. Typical minor amounts can be less than 50 mg of calcium per 226 g serving.

If aspartame is added to the dairy blend, all or a portion of the aspartame can be pre-blended with the fruit flavoring.

The fermented dairy blend in combination with the hydrated emulsifier can then be admixed with a gas, when the desired product is an aerated yogurt product or fermented mousse. In one such embodiment, the dairy blend/hydrated emulsifier combination is admixed with nitrogen gas. The gas can be charged into the dairy blend/hydrated emulsifier combination in accordance with any conventional method. For example, the gas can be forced through small orifices into the composition as the composition flows through a tube or vessel into a mixing chamber, where uniform distribution occurs. Any conventional nontoxic, odorless, tasteless gas, such as air, nitrogen, nitrous oxide, carbon dioxide, and mixtures thereof can be used.

In accordance with some embodiments of the invention, the fermented dairy blend can be aerated or whipped while maintained within a desired temperature range. Typically, the fermented dairy blend will be aerated from a native density of about 1.1 g/cc to a density in the range of about 0.56 g/cc to about 0.9 g/cc, or in the range of about 0.7 g/cc to about 0.8 g/cc. The skilled artisan can select a commercially available aerator/mixer for use herein. One suitable aerator in accordance with the inventive concepts is a Tanis Rotoplus 250 aerator available from Tanis Food Tec in The Netherlands. The Tanis Rotoplus aerator consists of a mixing chamber fed by a positive displacement pump and air flow system. Product flow is controlled by pump speed adjustment and airflow is controlled by flow meter adjustment. Stainless steel concentric rows of intermeshing teeth on a stator and a rotor produce a uniformity and consistency in the mix. A coolant, for example glycol, can be used in a jacket surrounding the mix chamber to maintain a preferred constant temperature in the range of about 4° C. to about 30° C., or about 4° C. to about 15° C., or in the range of about 4° C. to about 7° C. during aeration. The mixer can shear the dairy blend and gas, thus allowing the hydrated emulsifier blend to adhere and maintain separation of the dairy blend and gas creating the desirable air cells.

A pressure in the range of about 15 psi to about 30 psi can be maintained in the mixer to aid in the formation of air cells. The aerated dairy blend can be gradually transported from those pressures to atmospheric pressure; the gradual shift in pressure reduces air cell collapse.

The ratio of dairy blend to gas can be in the range of about 3:1 to about 1:1, or in the range of about 2:1.

During aeration, it can be important to control temperature to allow large visible air cells to form more readily. Maintaining the temperature in the ranges identified above can be important to control the final density of the product which, in turn, can be important to fast formation of large visible air cells and to minimizing air cell collapse upon extended storage. It will be appreciated that desirable large visible air cells form at 24 to 48 hours with whipping and filling temperatures in the above-mentioned temperature ranges.

In some embodiments, the aerated dairy blend can be developed by decreasing the amount of gelatin in the dairy base, increasing the temperature of the product to about 30° C. to about 45° C., admixing the hydrated emulsifier at a temperature of about 30° C. to about 45° C., and thereafter admixing the nitrogen gas at atmospheric pressure.

The aerated dairy blend (along with any flavor components included) can then be transported to a holding tank, if desired, and held for a desired amount of time. In some embodiments, for example, it can be desirable to retain the aerated dairy blend in a holding tank for a time period in the range of about 5 to about 15 minutes.

The aerated dairy blend can then be packaged in a conventional manner for handling and storage purposes. The aerated dairy blend is charged to a conventional container for yogurt products, such as coated paper or plastic cups or tubes fabricated from flexible film packaging stock. After filling, the filled containers are applied with a lid or other closure or seal means, assembled into cases, and entered into refrigerated storage for distribution and sale. In some embodiments, air cells in the yogurt product can achieve visible size within about 24 to 48 hours after fill, such sizes in the range of about 130 to about 3,000 μm. About 24 to 48 hours after fill, the aerated dairy blend can achieve a viscosity of about 52,000 cps to about 55,000 cps.

Typical product attributes of the inventive sweet brown yogurt products include the following. The yogurt products can exhibit a mild yogurt character, as a result of the cultures selected and utilized in accordance with the invention. Thermophilic cultures described herein can generate less lactic acid (thus providing a less acidic yogurt product) and less acetaldehyde (thus reducing the characteristic flavor of the yogurt product). Typically, the yogurt products exhibit a maximum change in pH level from the time of product formulation (initial pH) through the end of shelf life (for example, a period of approximately 8 weeks) of about 0.2 pH units. Notwithstanding the mild yogurt character, the inventive yogurt products are generally manufactured and stored at higher pH levels than conventional yogurt products. The inventive yogurt products can include a low water activity sweet brown component (such as the low water activity chocolate flavor described for purposes of illustration herein). The low water activity sweet brown component can assist in providing a yogurt product that includes an admixed flavor (as opposed to flavor components that are maintained separate from the yogurt base until the time of consumption) that contributes to a balanced, sweet brown-flavored yogurt product.

The invention will now be described with reference to the following non-limiting examples.

### EXAMPLE 1

A low-density aerated chocolate yogurt was prepared as follows.

TABLE 1
Aerated chocolate yogurt.

| | Amount (weight |
|---|---|
| Ingredient | percent) |
| Water | 63% |
| Non-fat dried milk | 11% |
| Cream | 10% |
| Sweetener | 14% |
| Stabilizers (starch, gelatin) | 2% |
| Milk solids nonfat | 11% |
| Butterfat | 4% |
| Total solids | 39% |

A yogurt base comprising water, non-fat dried milk, cream, sugar, starch, gelatin, and corn syrup (using amounts identified in Table 1) was homogenized and pasteurized. The heat-treated base was cooled and starter culture added. The cultured yogurt base was fermented under standard fermentation conditions to a pH of 5.0 and thereafter cooled to refrigeration temperatures (1° C. to 10° C.). Thereafter, the hydrated emulsifier blend consisting of water, sodium stearyl lactylate, and a lactylated blend of mono- and di-glycerides available from Danisco Cultor in Copenhagen, Denmark under the trade designation Lactem P22 in an amount of 3% at a temperature of 5° C. was folded into the fermented dairy base. A chocolate syrup having a water activity of less than 0.8 was added to the yogurt base in an amount of 8% (based upon the total weight of the yogurt formulation). The chocolate syrup had a soluble solids content of 67-71 (Brix) and pH in the range of 5.8 to 6.2. The chocolate syrup was added at a temperature of about 5° C. to the yogurt base.

The following minors were also added at this stage: chocolate flavors (less than 0.5%) and salt (0.08%).

The yogurt blend was then aerated with nitrogen gas in a Tanis Rotoplus 250 aerator to a finished density of 0.75 g/cc. The aerated product was placed in a holding tank for 5 minutes and then packaged in plastic containers with minimal shear. The chocolate yogurt product was stored at refrigerated temperatures. After refrigerated storage for approximately 3 weeks, the chocolate yogurt exhibited a pH of about 4.9. After refrigerated storage for approximately 8 weeks, the chocolate yogurt was found to maintain the pH level of 4.9.

The chocolate yogurt product exhibited a rounded, sweet brown chocolate flavor that was balanced with the characteristic yogurt flavors.

### EXAMPLES 2-4

Chocolate yogurts of various fat levels are prepared as follows.

TABLE 2
Chocolate yogurt

| | Amount (weight |
|---|---|
| Ingredient | percent) |
| Water | 64% |
| Non-fat dried milk | 9% |
| Cream | 8% |
| Sweetener | 16% |
| Stabilizers (starch, gelatin) | 2.5% |
| Milk solids nonfat | 9% |
| Butterfat | 3% |
| Total solids | 29.5% |

TABLE 3
Chocolate lowfat yogurt.

| | Amount (weight |
|---|---|
| Ingredient | percent) |
| Water | 73% |
| Non-fat dried milk | 9% |
| Cream | 3% |
| Sweetener | 12% |
| Stabilizers (starch, gelatin) | 2.7% |
| Whey protein concentrate | 1% |
| Milk solids nonfat | 8% |
| Butterfat | 1% |
| Total solids | 25% |

TABLE 4
Chocolate nonfat yogurt.

| | Amount (weight |
|---|---|
| Ingredient | percent) |
| Water | 79% |
| Non-fat dried milk | 9% |
| Stabilizers (starch, gelatin) | 2% |
| Sweetener | 8% |
| Whey protein concentrate | <1% |
| Milk solids nonfat | 8% |
| Butterfat | 0.1% |
| Total solids | 18% |

A yogurt base is prepared as described in Example 1 (using amounts indicated in Tables 2-4), and a started culture is added. The cultured yogurt base is fermented under standard conditions to a pH of 5.0 and thereafter cooled to refrigeration temperatures (1° C. to 10° C.). A chocolate syrup having a water activity of less than 0.8 (described in Example 1) is added to the yogurt base in an amount of 8% (based upon the total weight of the yogurt formulation).

The following minors are also added at this stage: chocolate flavors (less than 0.5%) and salt (0.08%).

After admixture of the yogurt base, chocolate flavor and minors, the yogurt product is placed in a holding tank for 5 minutes and then packaged in plastic containers with minimal shear. The chocolate yogurt product is stored at refrigerated temperatures.

### EXAMPLE 5

A chocolate yogurt was prepared as follows:

TABLE 5
Chocolate lowfat yogurt.

| | Amount (weight |
|---|---|
| Ingredient | percent) |
| Water | 73% |
| Non-fat dried milk | 9% |
| Cream | 3% |
| Sweetener | 12% |
| Stabilizers (starch, gelatin) | 2.7% |
| Whey protein concentrate | 1% |
| Milk solids nonfat | 8% |
| Butterfat | 1% |
| Total solids | 25% |

A milk base comprising water, non-fat dried milk, cream, sugar, starch, gelatin, and corn syrup (using amounts identified in Table 5) was homogenized and pasteurized. A chocolate syrup having a water activity of less than 0.8 was added to the heat treated milk base in an amount of 8% (based upon the total weight of the yogurt formulation) to form a chocolate flavored base. Starter culture was then added to the chocolate flavored base. Packaging cups were filled with the inoculated but unfermented milk base and the filled cups were held quiescently at warm temperatures (approximately 40° C. to 50° C.) to allow the yogurt to ferment therein to form a set-style yogurt.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims. All patents, patent documents, and publications cited herein are hereby incorporated by reference as if individually incorporated

1. A fermented dairy product comprising:
a. fermented dairy base containing active cultures; and
b. a low water activity chocolate base component admixed within the fermented dairy base.

2. The fermented dairy product according to claim 1 wherein the fermented dairy product has a pH of 4.7 to 5.3.

3. The fermented dairy product according to claim 1 wherein the low water activity chocolate base component has a water activity of 0.85 or less.

4. The fermented dairy product according to claim 1 further comprising additional flavor components.

5. The fermented dairy product according to claim 1 further comprising particulates.

6. The fermented dairy product according to claim 1 wherein the fermented dairy product is an aerated yogurt.

7. The fermented dairy product according to claim 1 wherein the fermented dairy product is a fermented mousse.

8. The fermented dairy product according to claim 6 or 7 wherein the aerated yogurt has a density of 0.8 g/cc or less.

9. The fermented dairy product according to claim 1 wherein the fermented dairy product is a stirred-style yogurt product.

10. The fermented dairy product according to claim 1 wherein the fermented dairy product is a set-style yogurt product.

11. The fermented dairy product according to claim 1 wherein the low water activity chocolate base component is present in an amount of 5 to 15 percent by weight, based upon the total weight of the fermented dairy product.

12. A fermented dairy product comprising:
a. fermented dairy base containing active cultures; and
b. a low water activity sweet brown component admixed within the fermented dairy base.

13. A method for preparing a fermented dairy product comprising steps of:
a. fermenting a dairy base by lactic fermentation to a pH of 4.7 to 5.2 to provide a fermented dairy base;
b. cooling the fermented dairy base;
c. admixing a chocolate base component with the fermented dairy base to form a chocolate flavored fermented dairy product; and
d. packaging the chocolate flavored fermented dairy product.

14. The method according to claim 13 wherein the fermenting step comprises lactic fermentation to a pH of 4.7 to 5.2.

15. The method according to claim 13 wherein the cooling step comprises cooling the fermented yogurt base to a temperature sufficient to arrest fermentation of the yogurt base.

16. The method according to claim 13 wherein the admixing step comprises admixing a low water activity chocolate base component with the fermented yogurt base.

17. The method according to claim 16 wherein the admixing step comprises admixing a chocolate base component having a water activity of 0.85 or less with the fermented yogurt base.

18. The method according to claim 13 wherein the admixing step comprises admixing the chocolate base component in an amount to provide a chocolate flavored fermented dairy product containing 5 to 15 percent by weight, based upon weight of the fermented dairy product, of the chocolate base component.

19. The method according to claim 13 further comprising admixing additional flavor components prior to packaging the chocolate flavored yogurt product.

20. The method according to claim 13 further comprising a step of storing the chocolate flavored fermented dairy product at refrigeration temperatures.

21. A method for preparing a fermented dairy product comprising steps of:
a. fermenting a dairy base by lactic fermentation to a pH of 4.7 to 5.2 to provide a fermented dairy base;
b. cooling the fermented dairy base;
c. admixing a sweet brown base component with the fermented dairy base to form a sweet brown flavored fermented dairy product; and
d. packaging the sweet brown flavored fermented dairy product.

22. A method for formulating a fermented dairy composition comprising:
a. selecting a bacterial culture for fermentation of a dairy base;
b. mixing the bacterial culture with a dairy base;
c. fermenting the dairy base with the bacterial culture to achieve a fermented dairy base having an initial pH level;
d. cooling the fermented dairy base to arrest fermentation and thereby form a fermented dairy product;
e. maintaining the fermented dairy product at refrigerated temperatures for a selected time;
f. subsequently determining a pH of the fermented dairy product;
g. comparing the initial pH level with the pH of the fermented dairy product to determine a pH change; and
h. selecting a bacterial culture that provides a pH change of 0.2 or less.

23. The method according to claim 22 wherein the step of maintaining the fermented dairy product at refrigerated temperatures for a selected time comprises maintaining the fermented dairy product at refrigerated temperatures for a period of two to eight weeks.

24. The method according to claim 22 further comprising a step of providing a base component comprising a flavor to the fermented dairy base to form a flavored fermented dairy product.

25. The method according to claim 22 wherein the step of fermenting the dairy base with the bacterial culture to achieve a fermented dairy base having an initial pH level comprises fermenting the dairy base with the bacterial culture to achieve an initial pH level of 4.7 to 5.2.

26. A refrigerator stable, fermented dairy product comprising fermented dairy base containing active bacterial cultures, wherein the active bacterial cultures provide a maximum pH change of 0.2 over shelf life of the fermented dairy product.
